(19) United States
(12) Patent Application Publication
(10) Pub. No.: US 2003/0126968 A1
(43) Pub. Date: Jul. 10, 2003

(54) Multi knife cutting device

(76) Inventor: Gopinath Baddepudi, Hyderabad (IN)

Correspondence Address: BADDEPUDI GOPINATH, 301-SARALARAMAM APARTMENTS, 16-11-310-8 SALIMNAGAR, HYDERABAD, A.P., 500036, IN

(21) Appl. No.: 10/042,433

(22) Filed: Jan. 10, 2002

Related U.S. Application Data
(60) Provisional application No. 60/300,605, filed on Jun. 25, 2001.

(51) Int. Cl. B26D 1/30

(52) U.S. Cl. 83/607; 83/932

(57) ABSTRACT

The invention relates basically to cutting vegetables efficiently either at home or in commercial establishments. It can also be used for other fibrous materials where practical. The aim is a low cost solution for an efficient device.

The new element is that of using several knives simultaneously without holding them in the hand except in Device C. Also the vegetables are not held by hand during cutting. These are excellent safety features. Such a device is not seen in the market.

The important and novel feature of this invention is the use of slotted platform to eject the cut pieces from between the knives during the cutting process. Without this feature the device becomes clumsy and unusable.

One more new element is the knives do not touch the board in Devices A and B. They are maintained at a distance of 2 mm above the slot bottom. This saves the board from knife marks and reduces the damage to the knife-edge.

Also the deice reduces the on hand through using several knives, because of the use of lever action in devices A and B.

### CROSS REFERENCE TO RELATED APPLICATIONS

Not applicable as this is a provisional application.

However I would like to mention that my application No. 98MAS/2001 dated Feb. 5, 2001 is pending with the Patent office, Chennai, for the same invention. Several improvements and modifications, which we are a result of testing the prototypes after Feb. 1, 2001, have been included in the U.S. application.

### BACKGROUND OF THE INVENTION

The invention described in this application belongs to the field of kitchen gadgets for cutting which are labor saving. The subject matter of the invention falls under the U.S. patent classification “083-CUTTING”.

I am listing below some U.S. patents that I came across during a search in the database. The devices, which I have invented, have no similarities with these.

| U.S. Pat. No. | Title |
|---|---|
| 6,148,704 | Vegetable cutting device |
| 6,052,910 | Vegetable cutting device |
| 5,950,515 | Apparatus for slicing vegetables |

The components used are knives, levers, springs, fasteners, stainless steel structurals, wooden board, plastic parts etc, which are items in common use. They have been assembled in a novel way to obtain an improved devise for cutting.

The prior art is cutting Vegetables with 1) a utility knife 2) Crank operated rotary cutter 3) a vertical knife fixed to a 50×100×500 mm wooden base.

The problems in cutting vegetables with a standard utility knife are well known and are listed below.

Skill development to ensure cutting is done without hurting the finger.

Pressure related strain on the hand.

Slow and tedious work which is repetitive

Knife touching the board causing scratches

Problem of excessive effort in cutting hard vegetables

Danger of knife slipping

Cutting finger chips is laborious

Both hands are to be used, one for holding, one for cutting

Reluctance to do the job as it is tedious work.

Getting uniform size is difficult

Damage to knife handle due to constant pressure

This invention should not be compared with food processors as they are motorized and the type of cutting is not comparable.

The Rotary type manual devices for vegetable cutting are also not comparable as sheet metal slits are used for cutting they cannot be compared to knives for cutting quality.

I was motivated to invent a more productive mechanism after seeing the drudgery inherent in cutting vegetables especially if one happens to be a vegetarian.

### BRIEF SUMMARY

This invention makes possible the use of several knives at a time in assembled form in conjunction with a special board, having a platform or grooves to perform vegetable cutting/dicing jobs in the kitchen both at home and in commercial establishments. This invention can also be used for cutting jobs other than Vegetables wherever it is practical. The knife assembly will not work if the special board is not used. Four different embodiments of the invention based on the mode of cutting action will be described in the ensuing pages. They are named Device A, Device B, Device C, Device D.

The advantages are

The increase in productivity

The time saving

Increased safety

No fear of cutting fingers

Even unskilled persons can do the job after a few minutes training

Choice of different sizes in the cut pieces

Uniformity in size

Use of lever action to gain mechanical advantage

Elimination of pressure induced injuries on the knife holding fingers

As the time taken is reduced, it results in cost reduction

As the job is done faster, vegetable cutting is no longer a tedious job. The monotony and repetitive job nature is reduced drastically. One can comfortably cut with 7 knives at a time.

There is psychological gain for the person who does vegetable cutting as he has an efficient device, He need not be afraid of injuring the fingers. Also he doesn't need long experience and special skills. There is no fear of fast moving motorized blades. Increase of productivity in cutting is achieved by using several knives assembled in a frame used in conjunction with a special board having a platform or grooves. The vegetables are supported on the platform that has slots in it, to receive the knives after the cutting is complete. In embodiment/device C there is no platform. Instead there are grooves in the board.

Safety is achieved by eliminating the need to hold the vegetables during cutting.

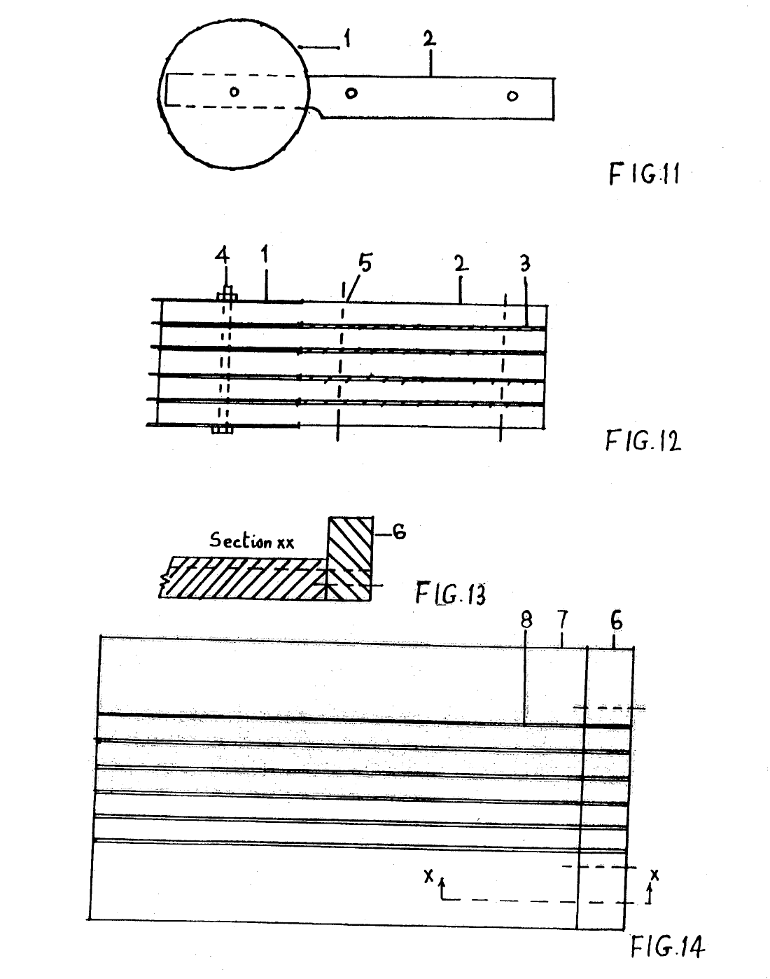

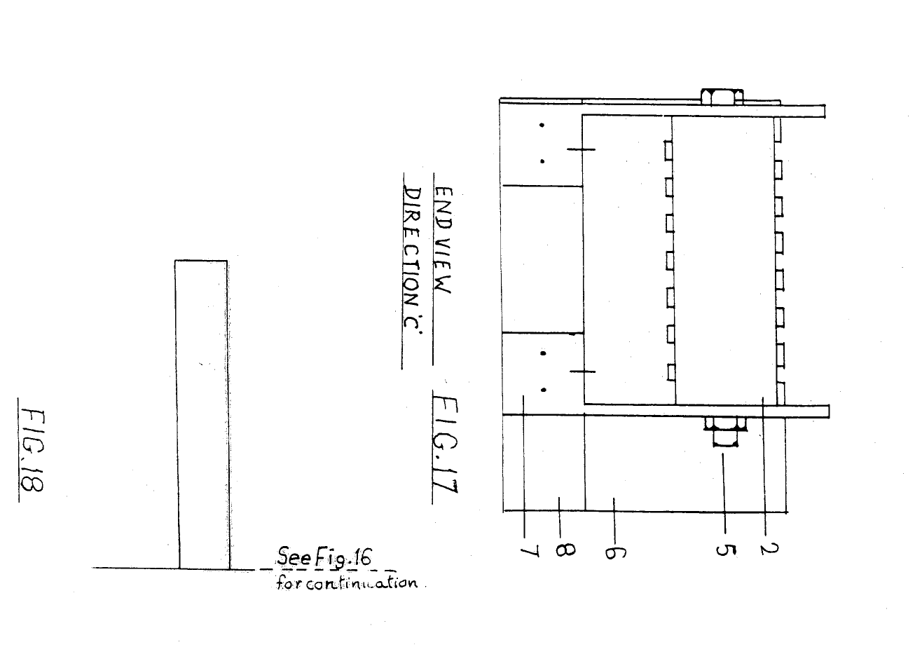

### BRIEF DESCRIPTION OF DRAWING VIEWS

| FIG. No. | Sheet no. | Details |
|---|---|---|
| 1 | 1/8 | Elevation - Device A |
| 2 | 1/8 | Plan - Device A |
| 3 | 2/8 | End view - Device A |
| 4 | 2/8 | Section AA, FIG. 1, Part 2, Knife assembly |
| 5 | 3/8 | Elevation, Part 17, Device A |
| 6 | 3/8 | Section BB, FIG. 1, Part 5, 13. |
| 7 | 4/8 | Plan view without part 15, Device B |
| 8 | 4/8 | Elevation view, Device B |
| 9 | 5/8 | End view, Part 6, 7 - Device B |
| 10 | 5/8 | U frame, part 15, Details, Device B |
| 11 | 6/8 | Knife assembly elevation, Device C |
| 12 | 6/8 | Knife assembly plan view, Device C |
| 13 | 6/8 | Section XX in FIG. 14 |
| 14 | 6/8 | Board part 7, plan view, Device C |
| 15 | 7/8 | Section AA of FIG. 16, Knife & Slots |
| 16 | 7/8 | Elevation, Device B, Heavy duty model |
| 17 | 8/8 | End view, Device B - Direction C in FIG. 16 |
| 18 | 8/8 | Continuation of FIG. 16, left side |
| 19 | 9 | Device B, using different cutting position |
| 20 | 10 | Device D, Elevation view |
| 21 | 10 | Device D, Plan view. |

### DETAILED DESCRIPTION OF THE INVENTION AND EMBODIMENTS

Device A. Multi Knife Cutting Device, Vertical Action

Construction Details

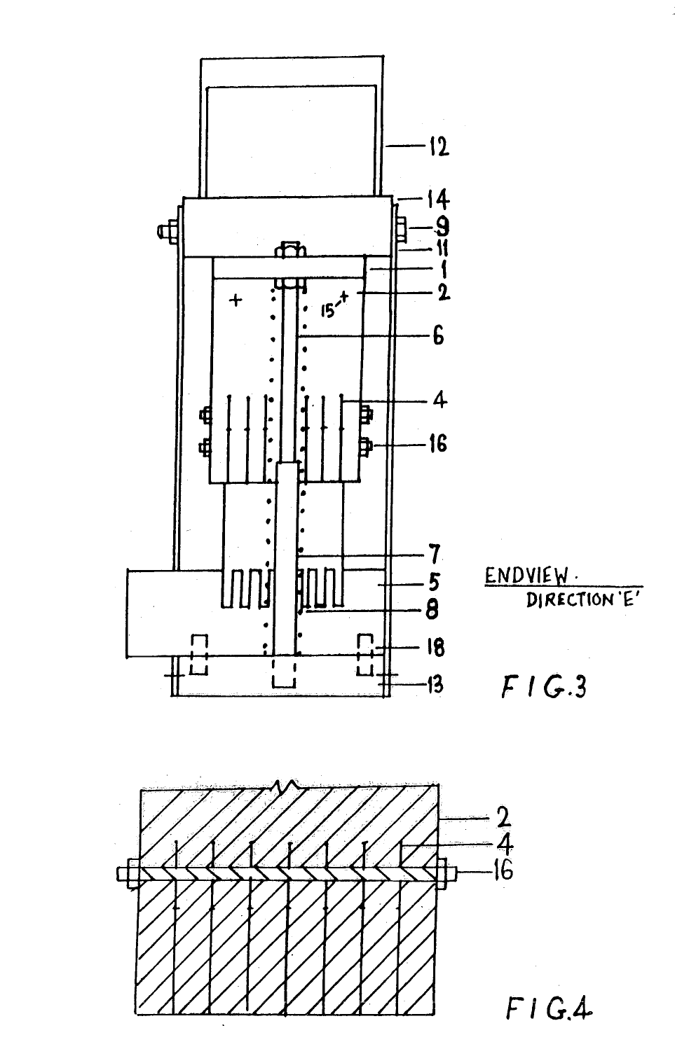

The general appearance of the device is shown in FIGS. 1,2 and 3. FIG. 3 is End view in direction E as shown in FIG. 1. The major components are listed below.

| | |
|---|---|
| Knife frame | Part 1, 2, 3, 15 |
| Knives | Part 4 |
| Platform | Part 5 |
| Telescopic guide | Part 6, 7, 8 |
| Hinge and lever | Part 9, 10, 11, 12 |
| Board | Part 13 |

Part 1 and 2, are made from nylon sheet 12mm thick and 72 mm wide. Part 1 is 210 mm and part 2 is 100 mm long. Part 3 is made from stainless sheet 2 mm thick×72 mm wide. It is made by bending to shape in a press. Part 1,2 and 3 are assembled together using 4 mm bolts at location 15. Part 2 serves as the knife holder.

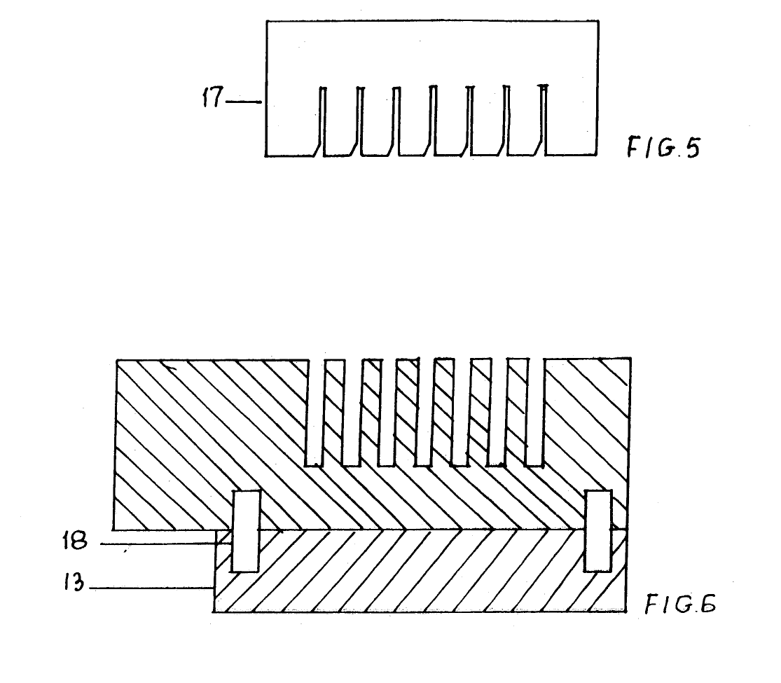

Part 4 is the knife (0.6 mm thick, 16 mm wide, 124 mm long). It is made of grade 420 stainless steel, hardened and has serrated edges. Seven of the knives are assembled in the frame at a center to center to distance of 9 mm from each other. The details of assembly are shown in FIG. 4. The knives go into the slots in Part 2 of the frame. The knives are positioned at an inclination of 16 mm in 100 mm in the frame. A 4 mm bolt part 16 is used to hold the knives in place in the frame. The 4.2 mm holes in the knife are at a distance 116 mm. The U shaped part of the frame part 3 has an inside dimension of 106 mm at the open end before knife assembly. When the knives are assembled it becomes 100 mm creating tension in the knives. This is due to the normal spring back, which occurs during bending of the U frame part 3.

Part 5 is the platform with slots for the knives and for placing the vegetables for cutting. It is made of Plastic material and has 7 slots 4 mm wide formed by 5 mm thick walls. The slot depth is 2 mm more than the knife width so that the knives do not touch the slot bottom at the end of the stroke. Part 2 of the Frame touches the board at the end of the stroke. The dimensions of the platform are 45×90×125 mm. The platform is fixed to the board using locating pins part 18. The slots on the platform match with the knife location on the frame.

Part 6 (8 mm SS rod 125 mm long with 8 mm threads at one end) and Part 7 (10 mm OD Seamless pipe) form the telescopic guide. Part 7 is pressed into a hole in the board 13. Part 6 is fitted to part two 8 mm nuts. It is essential that part 6 and 7 fitted perpendicular to their fixed bases. Part 7 is 95 mm long above the base. The telescope guide ensures that the frame moves in a vertical plane to match the knives with the slots on the platform 5. This is an essential function. Part 8 is a coil spring 180 mm long which keeps the frame lifted up in the starting position.

Part 9,10,11 and 12 make up the hinge and lever mechanism. Lever 12 is made of U shaped flat bar (stainless steel) 3×16 mm and is 320 mm long. It moves on the fulcrum 9 which is a 6 mm bolt holding the lever between the two angles 11 (25×40×2 mm). The angles are 240 mm long and are fitted to the board 13 with screws as shown in FIG. 1.

Part 13, board is 100 mm wide, 290 mm log and 20 mm thick made of plastic or wood. The angle supports 11 of the hinge mechanism 9,10 and the guide pipe 7 are fitted on this. Also the platform 5 is pressed on to the board.

Part 14 is a wooden member 20×30×100 mm fixed to part 1 by the lever part 12 transmits the downward force to the frame through part 14.

Part 17, FIG. 5, is a cross member made of plastic material 32×32×80 mm with 7 slots 16 mm deep in the 32 mm height, at the same spacing as the knives. It is placed over the center portion of the knives in the beginning of the cut. It has a taper in the beginning of the slots and a sliding fit for easy placement of the part over the knives. Its function is to prevent the knives from bending sideways during the cut. Bending will not allow the blades to enter the slot preventing the cutting.

### Functional Description

The Knife frame 1,2,3 which holds the knife assembly is normally in the top position held by the springs 8. The vegetables are laid out on the platform 5 in a single layer covering 70 percent of the area under the knives. The extra length can project on to the portion of the platform beyond the knives. Part 17 cross member is placed on the center of the knives at the top. The knife frame is pushed down using the lever 12 against the spring load and the resistance offered by the Vegetable. The knives cut the vegetables and then enter the slots in platform 5. During this process the side walls forming the slots of the platform push the cut pieces out of the knives. The cut pieces will be lying on the platform at the end of the lever's downward stroke. The cross member 17 also comes out onto the platform. The vertical travel of the knives is 85 mm This is sufficient to accommodate the height of most vegetables between the knives and platform, when the frame is in the top position.

The platform is 90 mm wide and 125 mm long to support the vegetables. When the knives are brought down inside the platform slots, the cut pieces of 8.4 mm width on the platform above the top edge of the knives. To start with the device is kept in ordinary tray made of plastic or stainless steel which has sufficient space for the device and for collecting the cut pieces. The cut pieces on the platform will fall into the tray by tilting the device sideways to the right. The lever can be released after the tilting. Then the springs take the frame to the top position. The fresh batch of vegetables is pushed under the knives and the next cut can be made. The tray is not shown in the drawings. Alternately a wooden spatula can push out the cut pieces into the tray.

Because there are 7 knives, the cutting operation is 7 times faster as compared to traditional cutting. For example, 6 beans can be placed on the platform and in one stroke 42 pieces are cut and lying on the platform. The time taken is same as that of a single knife cut.

With this device cutting finger chips is made easy and simple. The potato is cut into 9 mm thick slices in the traditional fashion with a standard knife. One slice is kept below the knives and the lever pulled down. The slice is cut into 8 finger chips in one stroke. The process is repeated for all the slices.

The following features make the device highly safe.

The vegetables are not held by hand during cutting

The fingers are faraway from the knives during the cut

In the starting position when vegetables are being placed the knives are supported by springs and there is no danger of knives coming down.

I have built a prototype at home with help from nearby workshops for bending and slot cutting. It is working as described above. A much better functioning device can be built with access to presses and machine tools in a manufacturing facility.

Heavy Duty Model—Device A

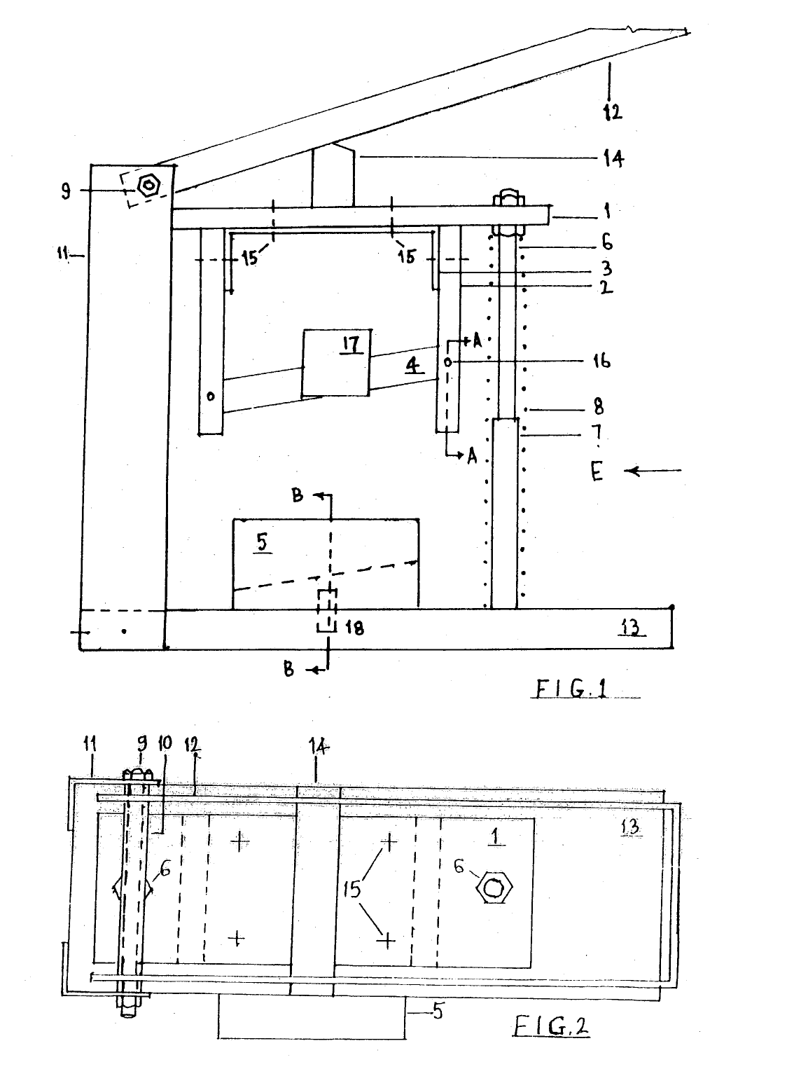

The device described in the earlier paragraphs, FIG. 1 and 2, uses knives of cross section 16×0.6 mm. As the knives were of a light section it was necessary to use cross member part 17 to prevent the blades from bending and fouling with the slots. It is possible to convert this device to a heavy-duty model by increasing the knife size to 25×1 mm from 16×0.6 mm and the platform height is increased to 53 mm from 45 mm. There is no other change. The moment of inertia of the new cross section is 7 times that of 16×0.6 mm. Separate drawings are not made for this as the only difference is in the knife size and platform height. All other features are as in FIGS. 1 and 2. This results in minimum bending of the knives on load. In trials with the prototype it is found that part 17 cross member is not required to be used for cutting. This results in a faster and simpler operation of cutting.

Lighter model will be good for softer vegetables, as cutting effort required is less. Heavier model will be suitable for items like potatoes and carrots.

Other Features

The device shown in FIG. 2 is meant for cutting 8.4 mm thick cut pieces. The center distance between two knives is 9 mm. It is designed for fitting 7 knives at 9 mm centers. However, it can be used for cutting 18 mm thick cut pieces by fitting the knives only in 4 slots leaving 3 positions blank (No. 2,4 and 6).

It is proposed to provide an optional unit of part 2, that has knives at 6.6 knives at 6.6 mm spacing and a cut piece size of 6 mm. This device can be used also for 12.6 mm thick pieces by dropping knife nos. 2,4 and 6. With two numbers knife holders part 2 there is a choice between 6,9,12.6 and 18 mm pieces that can be cut. The platform needs to be changed when the knife assembly is changed.

Opening 4 mm bolts at location 15 can interchange the knife holder 2. The knife part 1,2,3 can be lifted out of the guides by part 9 bolt. This facilitates changing of frames or cleaning of the knives.

Placing it under running water can easily clean the device. The knife assembly is designed for easy replacement of knives. The knives are under tension as described earlier which is a good feature for cutting. The force required for cutting is not high as lever action is used. However when cutting items like carrots the resistance is comparatively high. Care should be taken not to put too many carrots on the platform. It is recommended to cut them into longitudinal pieces by normal knife before dicing with the device. Preparation of vegetables like cleaning is recommended before cutting with the device.

Though the device shown, in the figure has 7 knives at 9 mm to centre distance covering a space of 55 mm between the 7 knives, it is possible to design the device for more number of knives keeping in consideration, the stiffness of knives which is dependant on width, thickness and length of the knife, the effort required for cutting, the hardness of the vegetables being cut, the spacing between the cuts. The limit is the bending of the knives excessively sideways when they touch the platform walls next to the slots. This is overcome by using the cross member 17. The bending is minimized when 25×1 mm knife is used. The serrations in the knife edge and the quality of the edge sharpness also reduce the loads of cutting which in turn reduce the bending of the knives on load.

Device B. Multi Knife Cutting Device—Inclined Cutting Action

Construction Details

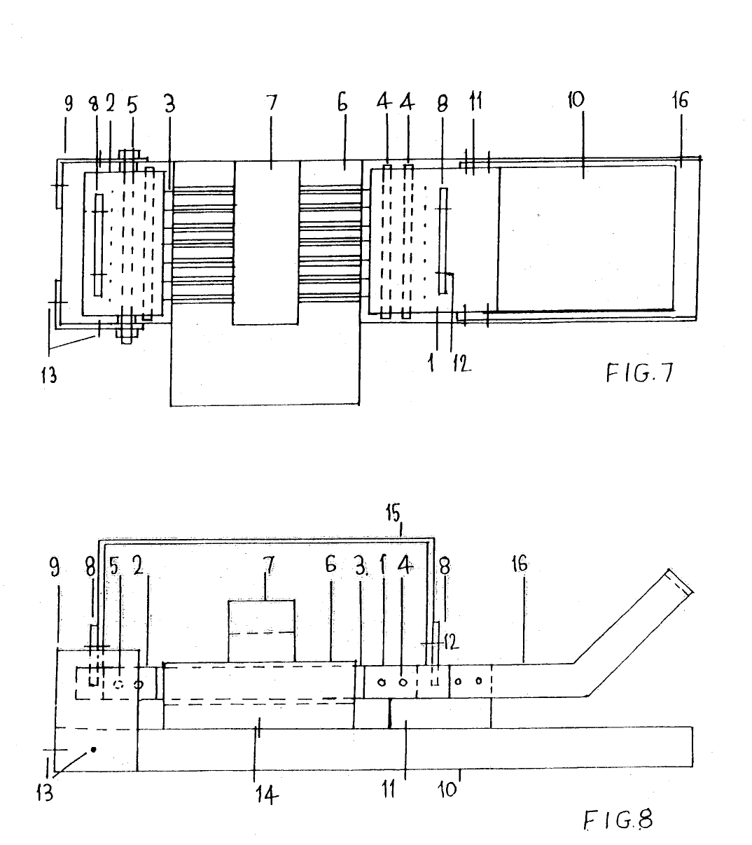

The general appearance of the device is shown in FIGS. 7 and 8. It differs from Device A in knife assembly, lever design and cutting action. Here the knife assembly moves in an arc with the hinge pin as the center of the circle. The feature of the platform with slots in common. The hinge mechanism ensures that the individual knives match with the slots in the platform. This device is simpler than device A and access to platform is better. The safety features are better in device A because of coil springs supporting the knife frame.

The major components are

| | PART NOS |
|---|---|
| Knife assembly cum lever | 1, 2, 3, 4, 16 |
| Hinge mechanism | 5, 9 |
| Platform | 6, 14 |
| Board | 10, 11 |

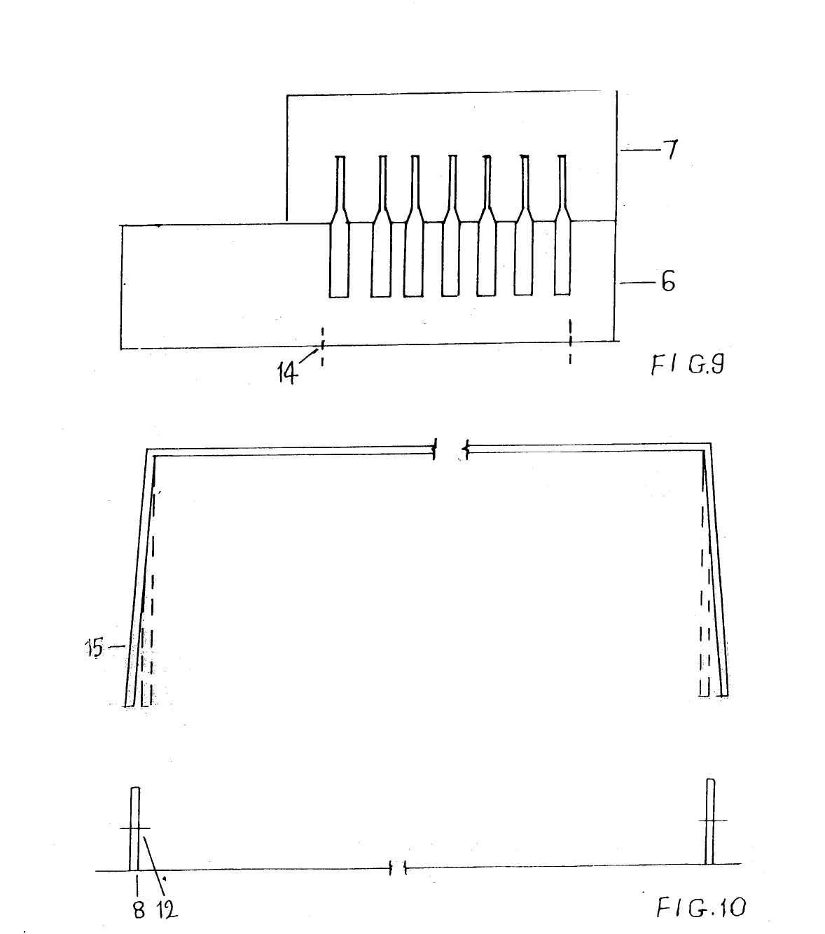

The board 10 (20×80×290 mm) is made of wood or plastic. On it are mounted the platform part 6, the stopper part 11, and the two angle supports 9 for the hinge mechanism. The platform 6 (32×92×120 mm) is made of wood or plastic and is fitted on the board with locating pins 8 mm dia at location marked 14 in FIG. 9. The platform has 7 nos 4 mm wide and 20 mm deep slots which match with the location and center to center distance of the 7 knives in the knife assembly. The stopper 11 (14×50×80 mm) is screwed to the board 12. The angles 9 (25×40×2 mm) are made of stainless steel and fixed to the board by screws shown at location 13, FIGS. 7 and 8. The angle is cut at the board top level on the 80 mm side. This is to facilitate the knife frame to be tilted back for rest position after the cutting stroke. The knives part 3 are 0.6 mm thick, 16 mm wide, 152 mm long with two holes of 4.2 mm dia on either side as shown in FIG. 8. They are made of grade 420 stainless steel with serrated edges. Seven of these knives are assembled in slots 0.7 mm wide, 26 mm deep at 9 mm center to center distance in part Nos. 1&2 which are knife supports and also act as a lever along with part 16 which is made of stainless steel flat 3×6 mm. Part 1 ions we 16×72×64 mm and part 2, 16×72×38 mm and they are made of either wood are plastic. Two Nos. 4 mm bolts part 4 are used in part 1 to assemble the knives with the frame as shown in FIGS. 7 and 8. Two nos stainless steel part 8 (3×28×52) made of 3 mm sheet are embedded in part nos 1 and 2 (FIG. 8). These are required to attach the U-frame part 15, FIG. 10. The U frame is made by bending to shape stainless steel sheet 2×52 mm. Height of the leg of part 15 is 60 mm and the open end free dimension is 174 mm resulting from the spring back of the pressing operation. When part 15 is pressed between the two supports part 8 and 4 mm bolts fitted in location 12 as shown in FIG. 8, the dimension becomes 164 mm. This increases the rigidity of the frame and also imparts tension to the knives. Part 2 of knife assembly has two 4.2 mm dia holes which pass 4 mm bolts, connecting the knives to frame. Out of these two bolts part 5 is longer and acts as a hinge bolt connecting the knife assembly to the vertical angles. This forms the hinge mechanism and has the required washers between the angles and part 2 to prevent excessive play. The second bolt is shorter and is recessed into the frame part 2. The knife cross member part 7 is made of wood (32×32×80 mm). It has 7 slots at 9 mm centers (FIG. 9). Each slot is 1 mm wide, 16 mm deep with tapered edges in the bottom for easy sliding on to the knife assembly during the cutting operation.

Functional description

The cutting operation is described below. Raise the knife assembly and lean back on the board at the hinge end in vertical position. Place the vegetables to be cut on the platform 6 with the length of the vegetable across the knives covering not more than 70 percent of the area in a single layer. Hold the knife assembly at the edge lever part 16 away from the knives and bring it down close to the vegetables and slide part 7 on to the center of the knives. Now push the knife assembly firmly over the vegetables and into the platform slots till it comes to rest on part 11. The knives do not touch the bottom of the slots as they are 2 mm deeper than the knife bottom edge.

With this the knives cut the vegetables, the pieces are pushed out of the spaces between the knives on to the platform and the cross member 7 also comes out. The cut pieces can be collected in a tray (not shown) kept below the device by tilting the device or they can be pushed into the tray by a spatula. The device is ready for the next cycle of cutting. One cutting cycle takes less than a minute, cutting for example six beans into pieces in a single cut. This makes the device highly productive.

For cutting finger chips the potato is to be cut first into slices in the traditional way. The device can cut each slice into 8 strips in one cutting stroke. This device makes finger chip cutting easy and fast.

Multi Knife Cutting Device—Inclined Cutting Action—Heavy-duty model.

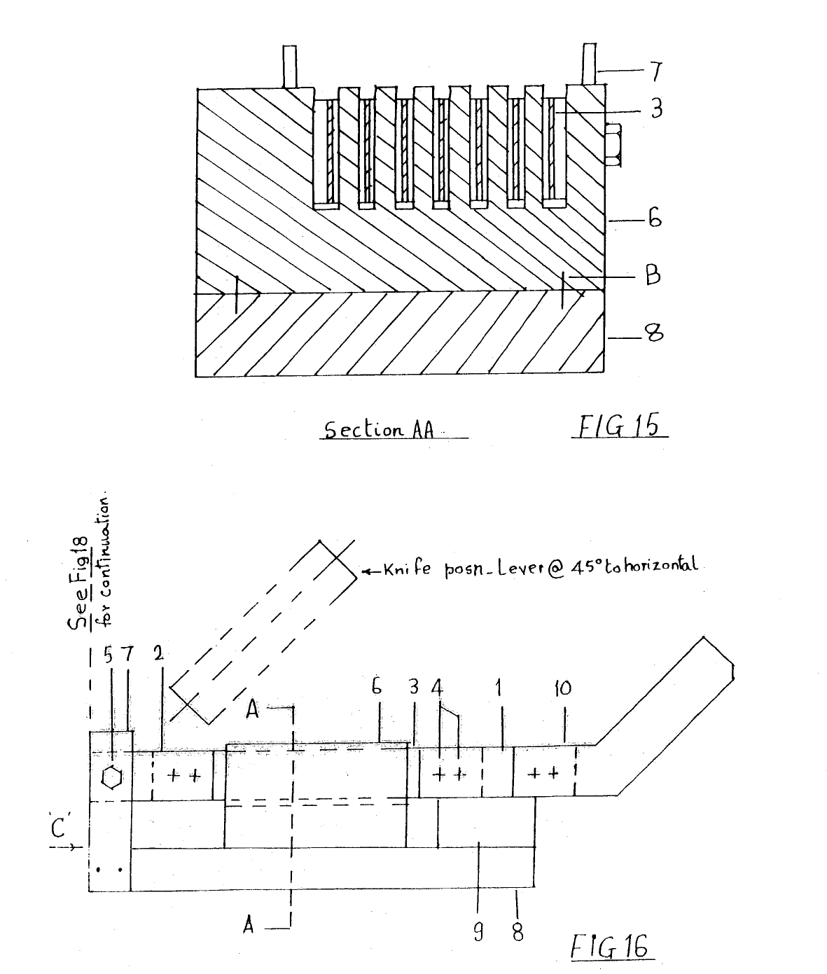

Described below is an embodiment which uses knives of a bigger cross section, resulting in better performance. FIGS. 15 to 18 show the details of this model. Following are the differences from the standard model.

Knife size is 25×1 mm as compared to 16×0.6 mm

Part 8 and 15 of FIG. 8 become redundant, as the knife assembly is strong by itself.

Part 7 of FIG. 8 is also not required as the knives do not bend in normal operation.

This makes the cutting operation simpler and faster than the standard model.

Construction Details

| Part | Item | Material | Dimension, mm |
|---|---|---|---|
| 1, 2 | Knife supports | Wood/plastic | 25 × 70 × 76, 25 × 70 × 210 |
| 3 | Knife, 7 nos | St. steel gr. 420 | 1 × 25 × 160 |
| 4 | 4 mm bolts, knife | Standard | 4 × 80 |
| | assembly | | |
| 5 | 6 mm bolt, | Standard | 6 × 90 |
| 6 | Platform | Wood/Plastic | 50 × 90 × 100 |
| 7 | Hinge support | S.S. angle | 20 × 20 × 3 |
| 8 | Base board | Wood/Plastic | 20 × 100 × 220 |
| 9 | Knife rest | Plastic | 20 × 45 × 100 |
| 10 | lever | St. Steel flat | 3 × 25 |

Platform 6 is pressed onto baseboard 10 by 2 nos 8 mm locating pins as shown in FIG. 15 location B. Seven knives are assembled in knife part 1,2 at a center to center distance of 9 mm. The knife assembly is fixed to vertical supports 7 by means of bolt 5, which acts as a hinge mechanism. The vertical supports are made of stainless steel angles and are screwed to the board. The horizontal distance between the angles is the same as the width of part 2 so that there is no play when the knife assembly is moved up and down. The web of the angles parallel to the 100 mm of the board is cut flush with the board top (FIG. 17)so that the knife frame part 2 does not foul with the board, when the knife frame is lifted for the cutting operation. The 4 mm wide slots in the platform 6 (FIG. 15) match with the corresponding knife positions in the knife assembly. The use of 25×1 mm knives which have a moment of inertia seven times that of 16×0.6 mm the device sturdy. This also makes the U frame and cross member of the standard model, FIG. 8, superfluous.

Functional Description

The knife assembly is lifted up by one hand using lever 10 and moving anti clockwise. The movement should be sufficient to place vegetables on the platform. Using the second hand the vegetables are spread on the 90 mm wide platform in a single layer with their length across the knives. Applying hand force at the end of the lever 10, the knife assembly is brought down on the vegetables till it comes to a rest on part 9. With this one operation all the vegetables on the platform we cut into 8 mm pieces. The pieces can be emptied into a tray kept beside the device by tilting the device or by pushing with a spatula. Now the device is ready for the next cut. In case of hard vegetables additional force can be applied by lifting up part 2 at the left end in addition to the downward force on lever 10 using both the hands. Force on part 2 acts as a class 1 lever. The device should be kept at the edge of a table so that part 2 of the knife assembly can move below the board level when the assembly is lifted up for placing the vegetables. The device is seven times faster and also safe as the hands are away from the knives and also the vegetables during cutting. The approach to the vegetables is also better than other models.

Variation of Heavy Duty Model Device B

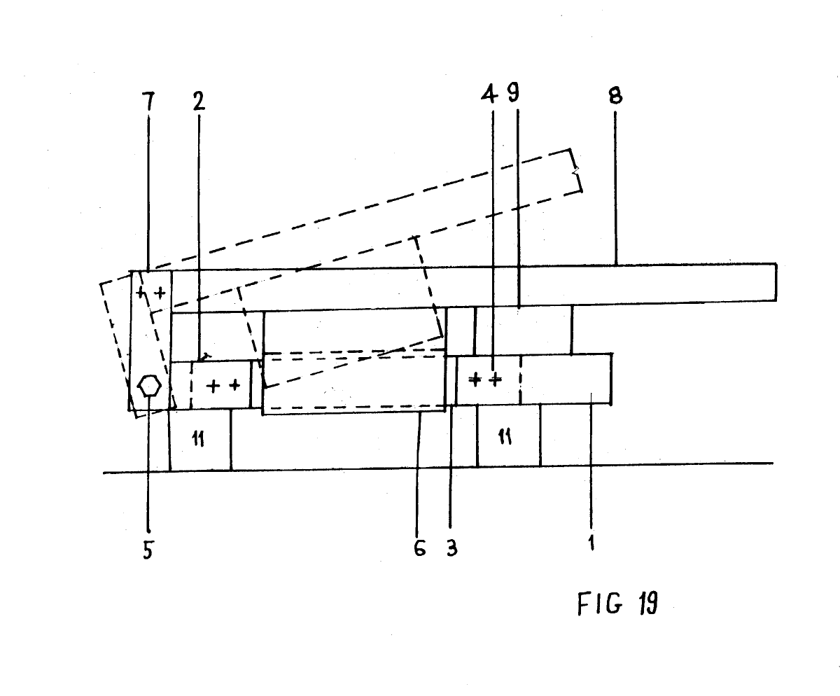

FIG. 19 shows the elevation of a second Device B model, where the position of the device for cutting is made upside down as compared to FIG. 16, which means the knife assembly is at the bottom and the base with platform is on top. The details are given below.

The construction of the device is same as Heavy-duty model shown in FIG. 16 except for lever part 10. The extended base part 8 acts as the lever, as the base is now on top. The knife assembly is without the lever as shown in FIG. 19 and is at the bottom. Part numbers are same as in FIG. 16 except for part 11 which are wooden blocks to support the device. The dotted lines in the FIG. 19 show the base and platform assembly in partly lifted position, with part 5 acting as the hinge.

Functional Description

The device is placed with the knife assembly (part 1,2, and 3 ) resting on two wooden blocks, part 11 on my plain surface as shown in FIG. 19. This creates space for the vegetables to fall down by gravity at the end of cutting stroke. The base with platform, part 6 and 8, is lifted up to make it vertical. The vegetables are spread on the knife assembly on the portion the knives part 3 are located. The base is brought down on to the vegetables, using hand force with the lever advantage. The platform ribs enter the slots between the knives after cutting the vegetables. The cut pieces fall on to the surface where the device is supported. This is an improvement over the previous mode of operation where the base part 8 is at the bottom, as the cut pieces fall down on their own, saving time and making the operation simple.

Device C. Multi Rotary Knife Cutting Device, Rotary Action

This is another embodiment using the principle of assembled knives and a specially designed board for cutting but the knife shape is different. This device is shown in FIG. Nos. 11 and 12.

Construction Details

This embodiment of the invention uses an assembly of rotary knives instead of straight knives along with a specially designed baseboard to accomplish the task of cutting vegetables or other materials. Stand alone knife assembly cannot perform the task. This device is meant for light work because of the features of the design.

Six circular knives part 1 of 0.6 mm thickness and 72 mm diameter are held together by a 4 mm bolt at location number 4 as shown in FIGS. 11 and 12. The knives are made from grade 420 Stainless Steel. There is a gap of 12 mm between the knives as illustrated in FIG. 12. The handle 2 extends beyond the fulcrum 4. A spacer 3, 1.2 mm thick is inserted between handles to facilitate play for the knives to rotate. Bolts shown at location 5 hold the handles together. The handles are 11 mm thick, 20 mm wide and 190 mm long, made of wood or plastic.

The board part 7(20×135×260 mm), which can be made of plastic or wood is designed to guide the knives during rolling and separate the cut pieces from the knives after the cutting is over. There are six grooves part 8 in the board 7 as shown in FIG. 14. Each groove is 5 mm deep and 1.2 mm wide and runs all through the board length. There is an end stop cum guide part 6 (20×40×135 mm) made of wood and screwed to the board part 7 at the end as shown in FIG. 14. It has vertical slots 1.2 mm wide corresponding with the groves in the board.

Functional Description

The vegetables are spread on the board before the end stop 6 FIG. 14. The roller knife assembly part 1 is placed in the grooves 8 and is rolled over the vegetables simultaneously applying downward force. The assembly 1 is pulled towards the slot in the end stop till the knives pass through the slot. The end stop separates the cut pieces from between the knives. With this single operation all the vegetables are cut into small pieces and get separated from the knives. This operation is several times faster than using a single roller knife. This device is meant for cutting items, which are not hard for example okra, beans etc. It is also good for cutting strips of rolled dough for deep-frying, pasta, or any similar flat material, which can be cut with single knife. The preparation of the vegetables is to be done as usual. It can also be used for cutting non food items like strips of leather etc.

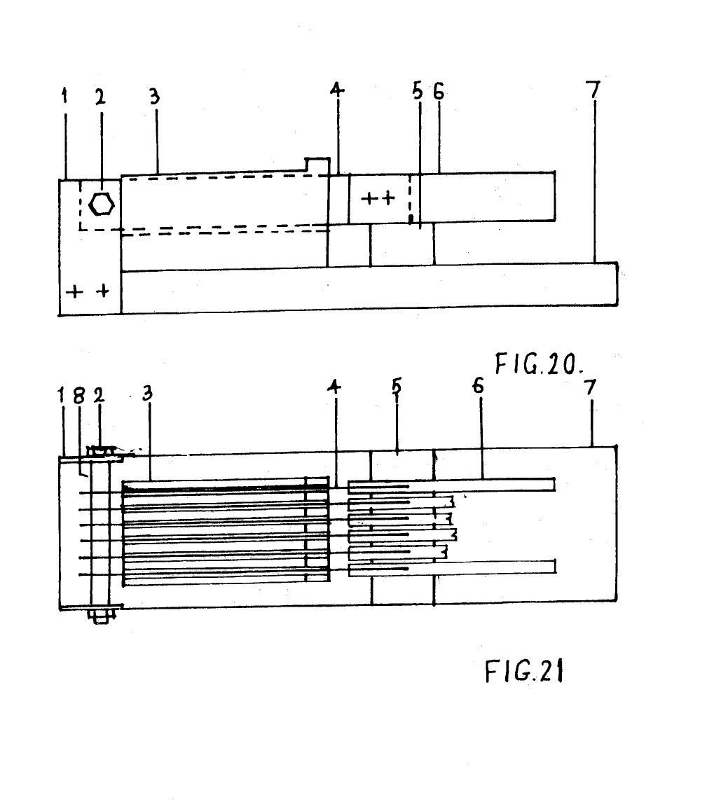

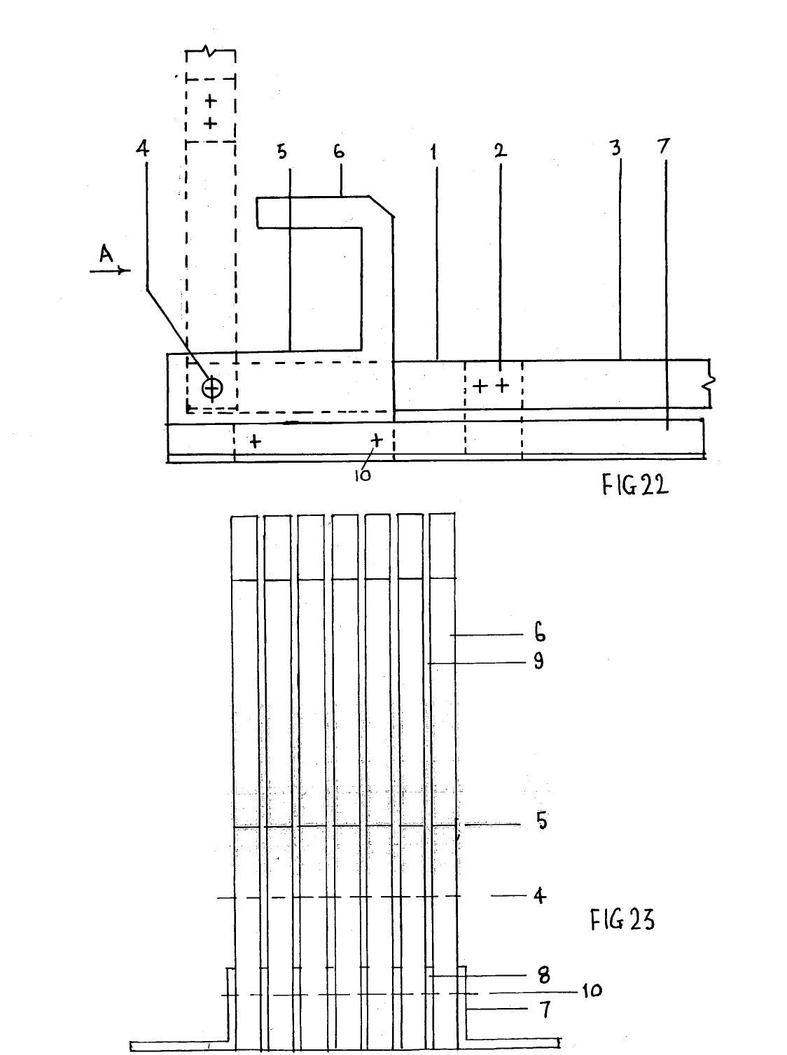

Device D. Multi Knife Cutting Device, Independent Knife Movement

| | | |
|---|---|---|
| FIG. 20. | Elevation view | .Sheet no. 10 |
| FIG. 21. | Plan view. | Sheet no 10 |

Construction Details

| | | | | |
|---|---|---|---|---|
| Part 1 | Support | 3 × 30 × 65 | mm | st. steel |
| Part 2 | bolt for knife assembly | 6 × 90 | mm | st. steel |
| Part 3 | slotted platform | 48 × 52 × 100 | mm | Plastic |
| Part 4 | Knife | 1 × 25 × 160 | mm | St. steel gr. 420 |
| Part 5 | Support | 20 × 30 × 75 | mm | Plastic |
| Part 6 | Knife handle | 6 × 25 × 100 | mm | Plastic |
| Part 7 | Base board | 20 × 75 × 270 | mm | wood/plastic |
| Part 8 | Spacer | 6 × 8 | mm | different lengths |

The supports part 1 are screwed on to the board part 7 at one end as shown in FIG. 20. The slotted platform part 3 containing 6 slots 3 mm wide is stuck to the base with adhesive at the location shown in FIG. 20. The six knives part 4 fitted with handles part 6, are fitted to the supports 1 using the bolt and spacers, part 2 and 8 so that the knives align with the slots in platform part 3. The support part 5 determines the position of the knife, leaving a clearance below and above the knife at the end of the stroke. FIG. 21 shows how the knives match with the slots in the plan view.

Functional Description

The whole potato is placed on the platform 3 close to the raised edge at one end, with the knives part 4 in vertical position. Then the knives are brought down and touch the potato top. The center distance between the knives is 8 mm. To cut the potato into slices the knives are brought down one by one, in quick succession into the slots. It is not advisable to bring down the knives simultaneously as the potato is large in size, which will cause the knives to bend sideways. This device is safer than single knife as the fingers are away from the knife. The device is also faster as all the knives we are ready for cutting and there is no upward stroke for each knife cut as in the case of single knife. The slices are uniform giving better appearance.

This device can also be used for of Okra, beans and slices of potato into small pieces by using all knives simultaneously. In this case the knives do not bend as the vegetable thickness is small compared to a whole potato. This deice can be classified as multi purpose as the knives can be used separately or simultaneously depending on the thickness of the item being cut.

Other Design Variations with the Same Principle

Two more embodiments are mentioned below which are variations using the principle mentioned in the section brief summary. I am not going into the details, as they are not more efficient than the three devices described above. However they can be built if the market economics demand.

i) Multi cut device without frame.

Knives are assembled in handles at each end without a frame similar to device B part 1 and 2. They can be used with a slotted platform base. Matching has to be done visually each time. There is no provision for tension. There is no hinge or lever mechanism.

ii) Multi cut device with frame but without levers.

The knives are assembled in a frame as in Device A part 1,2,3 and used in conjunction with a board but without telescopic guides or levers. Effort required is more with this device. Device A lever mechanism can be modified to that of an eccentric mechanism which can be mounted on top of part 1, supported by angles screwed to base part 13. A power drive can be devised by connecting a motor with gearbox to the eccentric mechanism.

I claim:

1. A multi knife cutting device having four embodiments, each embodiment consisting of an assembly of six to eight knives operating in conjunction with a slotted platform which is part of a board, to perform vegetable cutting manually at a faster rate than single knife.

2. A multi knife cutting device according to claim 1, where the four embodiments have, vertical, inclined or rotary-cutting actions, which are based on the way the assembly of knives moves in its cutting stroke.

3. A multi knife cutting device according to claim 1, where the slotted platform made up of thin walls of plastic or other material, performs the tasks of supporting the vegetables before cutting and separation of cut pieces from between the knives after cutting, and where in the slot location matches with the knife position.

4. A multi knife cutting device according to claim 1, where the fourth embodiment has knives which operate independently, to facilitate cutting of whole potatoes and similar vegetables into large slices, as compared to the first three embodiments where all knives are assembled in a frame so that they move together and are designed to cut vegetables of smaller diameter or thickness.

5. A multi knife cutting device according to claim 1, where the knives can be replaced easily, the spacing between knives can be modified, the knife edges do not touch the board after cutting the effort is reduced due to lever action and the safety is improved by keeping the hand away from the cutting edges.

6. A multi knife cutting device according to claim 1, where the embodiment named device B heavy duty model, can be used for cutting vegetables with knife assembly at the top or the knife assembly at the bottom in which latter case the cut pieces fall down from the device making the operation simpler.
